(19) United States
(12) Patent Application Publication
(10) Pub. No.: US 2017/0300214 A1
(43) Pub. Date: Oct. 19, 2017

(54) Three Dimensional Model Launch Tools And Methods Of Use

(71) Applicant: SAS Automation, LLC, Xenia, OH (US)

(72) Inventor: Kevin Roundtree, Xenia, OH (US)

(73) Assignee: SAS Automation, LLC, Xenia, OH (US)

(21) Appl. No.: 15/490,303

(22) Filed: Apr. 18, 2017

Related U.S. Application Data
(60) Provisional application No. 62/324,579, filed on Apr. 19, 2016.

(51) Int. Cl. G06F 3/0484; H04L 12/58; H04L 29/08; G06T 17/00

(52) U.S. Cl. CPC G06F 3/04842; H04L 67/06; H04L 67/02; H04L 51/08; G06T 17/00

(57) ABSTRACT

Methods and systems for launch tools incorporating at least one of launch features and selection features on websites to launch a 3D model from the website, from a 3D model file associated with a selected product, within a separate software application. For example, the website may include a shopping cart tool, and the product and associated 3D model file may be selected to populate a shopping cart such that a user may place an online order for the product. The user may also be able to view the 3D model of the 3D model file associated with the product through a launch tool, whether a virtual form of the product is already in the shopping cart or on another product selection page of the website. The launch tool automatically launches the separate software application with the 3D model.

### CROSS REFERENCE TO RELATED APPLICATIONS

This application claims the benefit of U.S. Provisional Application No. 62/324,579, filed Apr. 19, 2016.

### TECHNICAL FIELD

The present specification generally relates to launch tools to launch three-dimensional models from a website into a separate software application and, more specifically, to launch tools to launch three-dimensional models of a product from a website into a separate software application through a feature on the web site and methods of use of such tools.

### BACKGROUND

Users may download a three-dimensional model of a product from a website to be saved as a file at, for example, a personal computer. Users may then launch a separate software application, search for and select the downloaded model, and open the downloaded model in the separate software application to manage and/or modify the downloaded model.

Accordingly, as the above steps are disjointed, a need exists for alternative tools to streamline the process to open the three-dimensional model from the website in the separate software application and methods of use of such tools.

### SUMMARY

In one embodiment, a method for launching a three-dimensional model from a website into an application may include receiving through a user-interface of the website an input of a selection by a user of a selected product; and retrieving from a server, by a processor and through use of an http protocol, a 3D model file associated with the selected product. The method may further include selecting a launch feature on the user-interface of the website, wherein the launch feature is associated with the 3D model file, and automatically launching, via the processor, the 3D model file associated with the selected product in a display screen of the application.

In another embodiment, a system for launching a three-dimensional model from a website into an application may include a server, a processor communicatively coupled to the server, and non-transitory computer-readable storage medium storing one or more instructions. The one or more instructions, when executed by the processor, cause the processor to: receive an input of a selection by a user of a selected product from a user-interface of the website, and retrieve a 3D model file associated with the selected product on the website from the server through use of an http protocol. The one or more instructions, when executed by the processor, may further cause the processor to operate a launch feature associated with the 3D model file and based on a command code linked to a deep-link protocol associated with the application, and automatically launch the 3D model file associated with the selected product in a display screen of the application.

In yet another embodiment, a system for launching a three-dimensional model from a website into an application may include one or more servers, a processor communicatively coupled to the one or more servers, and non-transitory computer-readable storage medium storing one or more instructions. The one or more instructions, when executed by the processor, cause the processor to: receive an input of a selection by a user of a selected product from a user-interface of the website, and retrieve a 3D model file associated with the selected product on the website from the server through use of an http protocol. The one or more instructions, when executed by the processor, may further cause the processor to receive a user selection from the one or more command options, and automatically launch the 3D model file associated with the selected product in a display screen of the application based on the user selection.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a flow chart of a process for using a launch feature on a website-based tool to launch a three-dimensional (“3D”) model in a separate application to view the 3D model, according to one or more embodiments shown and described herein;

FIG. 2 is a flow chart of a process for using a selection feature on a website-based tool to select an option to launch a 3D model in a separate application to view the 3D model, according to one or more embodiments shown and described herein;

FIG. 3 schematically illustrates a system for implementing computer and software based methods to utilize the tools of FIGS. 1 and/or 2 to launch a 3D model in a separate application, according to one or more embodiments shown and described herein;

FIG. 4A is a schematic illustration of a user-interface of a website in which a user selects a product associated with a three-dimensional (3D) model file from a first device, according to one or more embodiments shown and described herein;

FIG. 4B is a schematic illustration of the 3D model file of the selected product of FIG. 4A launched into an application on a screen of the first device, according to one or more embodiments shown and described herein;

FIG. 4C is a schematic illustration of the 3D model file of the selected product of FIG. 4A launched into an application on a screen of a second device, according to one or more embodiments shown and described herein;

FIG. 4D is a schematic illustration of the 3D model file of the selected product of FIG. 4A emailed to a user from the first device and shown as an attachment or link with view options in an email on the second device, according to one or more embodiments shown and described herein;

FIG. 4E is a schematic illustration of the email of FIG. 4D and a launch of the emailed 3D model file in an application on the second device, according to one or more embodiments shown and described herein; and

FIG. 4F of a user-interface of a website in which a user selects a product associated with a three-dimensional (3D) model file on a website shown on a second device that is launched into an application on the second device, according to one or more embodiments shown and described herein.

### DETAILED DESCRIPTION

Referring generally to the figures, embodiments of the present disclosure are directed to launch tools incorporating launch features and/or selection features on websites to launch a 3D model from the website, from a 3D model file associated with a selected product, within a separate software application. For example, the website may include a shopping cart tool, and the product and associated 3D model file may be selected to populate a shopping cart such that a user may place an online order for the product. The user may also be able to view the 3D model of the 3D model file associated with the product through a launch tool, whether a virtual form of the product is already in the shopping cart or on another product selection page of the website. The launch tool automatically launches the separate software application with the 3D model. Reference will now be made in detail to embodiments of the launch tools to launch 3D models from websites in separate software applications, examples of tools and systems are illustrated in the accompanying drawings. Wherever possible, the same reference numerals will be used throughout the drawings to refer to the same or like parts. Various embodiments of the launch tools will be described in further detail herein with specific reference to the appended drawings.

An example of the shopping cart feature used on the website may be, for example, OPENCART, an open source shopping cart system for e-commerce online ordering systems. Non-limiting examples of the 3D models may include, for example, computer-aided design (“CAD”) files, computer-aided engineering (“CAE”) files, computer-aided manufacturing (“CAM”), and/or other like computer-aided three-dimensional files. These 3D models may be viewable in software applications such as CAD software. Other software applications to view the 3D models may include applications that permit viewing, management, and/or manipulation of the 3D models. An example of such a software application is the cloud-based tool FUSION 360™ by AUTODESK®, which is a 3D CAD, CAM, CAE tool that connects a product development process through a cloud-based platform.

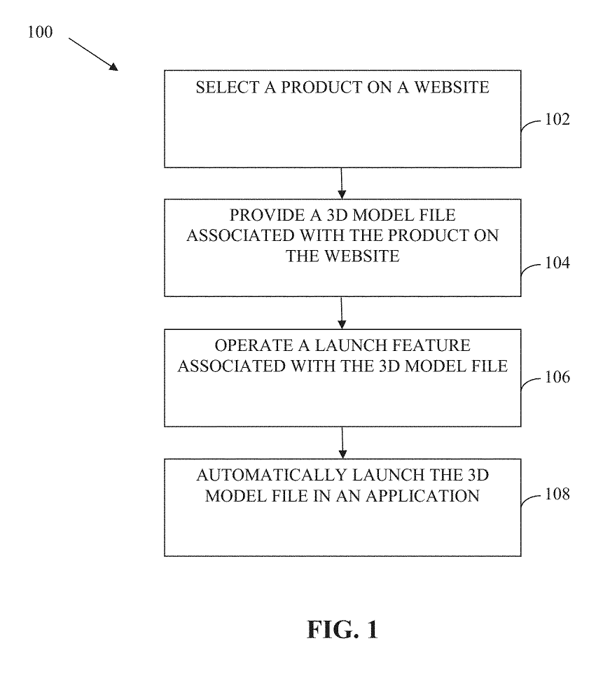

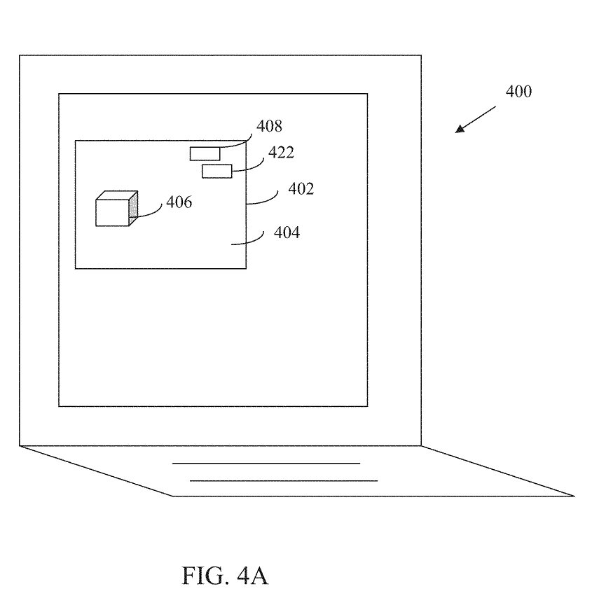

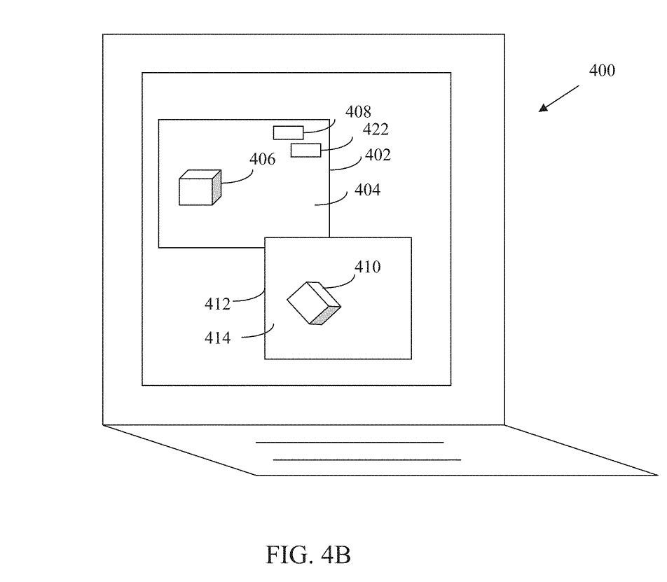

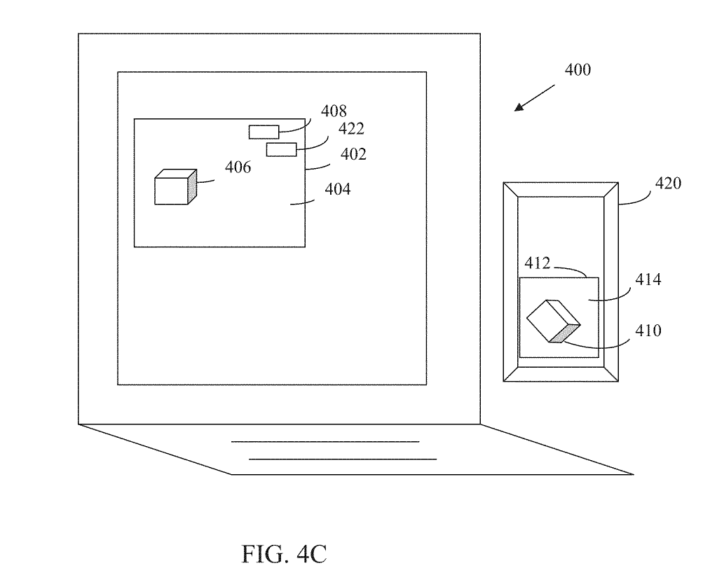

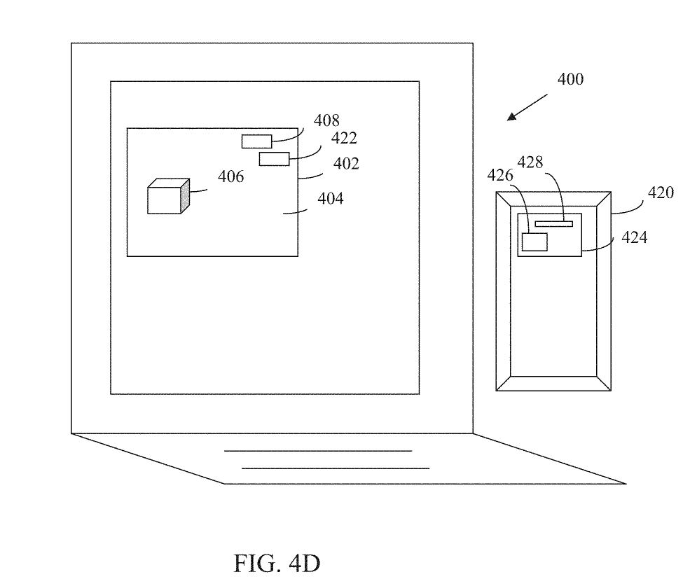

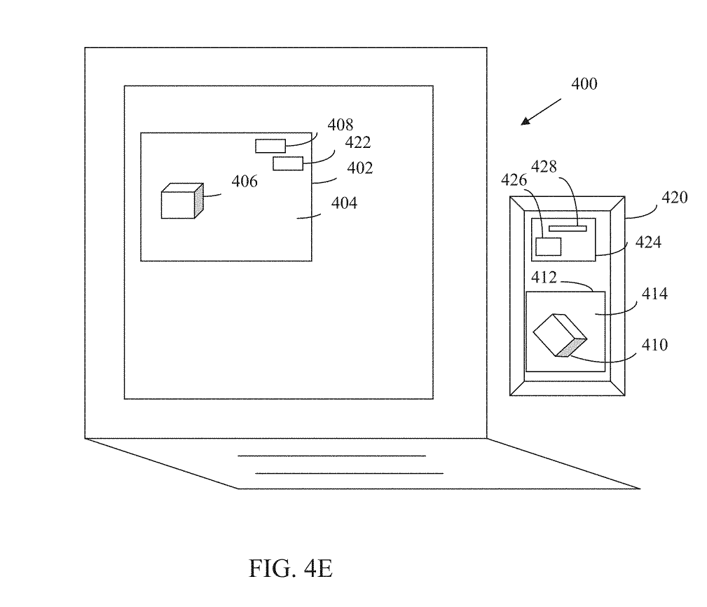

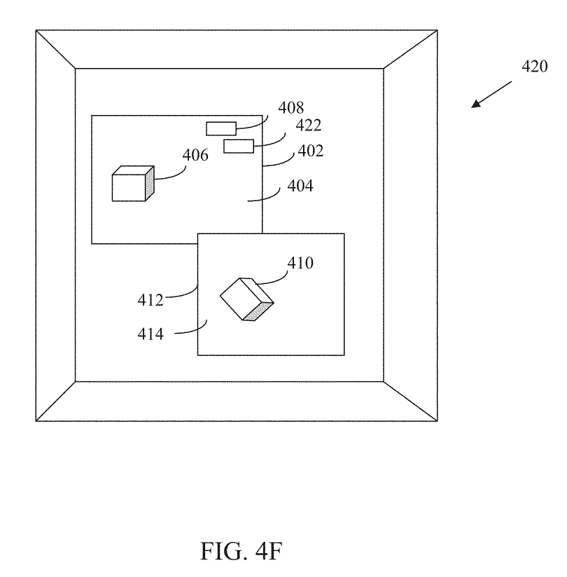

Referring to FIG. 1 and FIGS. 4A-4F, a flow chart of a process 100 for using a launch feature on a website-based tool to launch a 3D model in a separate application to view the 3D model is shown. In step 102, a product 406 is selected from a website 402. The product 406 be, for example, a manufactured part from a manufacturer or vendor's website that is to be a component in a user's overall design. The product 406 may have an associated 3D model file 410 that is stored in one or more servers accessible by the website 402 by, for example, use of an http protocol. Through use of the http protocol, the user is provided on the website 402 with the 3D model file 410 associated with the product in step 104.

In step 106, the user operates a launch feature that is associated with the 3D model file 410. The launch feature may be a clickable button 408 on the website labeled with instructions indicating that selection of the button will launch the 3D model file 410 in a separate software application 412. The user may then view, modify, and/or manage the 3D model file 410 of the 3D model in the separate software application 412. Thus, in step 108, based on operation of the launch feature by the user, the launch tool automatically launches the 3D model file 410 in the separate software application 412. For example, as described above, the user selects the clickable button 408 to launch the 3D model file 410 in the separate software application 412 in step 106, and, in step 108, the 3D model file 410 is automatically launched in a display screen 414 of the separate software application 412 without requiring the user to first save the 3D model file, separately open the separate software application, search for the saved 3D model file, and open the 3D model file in the separate software application.

In embodiments, the launch feature may be coded, or programmed, with one or more commands. A code may link to a deep-link protocol associated with the separate software application 412 and simultaneously retrieve the 3D model file 410 associated with a selected product 406 on the website 402 from a server storage location through use of the http protocol and utilize an open, import, or insert command associated with the deep-link protocol to launch the retrieved, associated 3D model file 410 in the separate software application 412. For example, utilization of the insert command may open up a blank new project in the separate software application 412, into which the retrieved 3D model file 410 is inserted. Use of the open command, by contrast, may open a new project in the separate software application 412, into which to open the retrieved 3D model file 410.

In embodiments, the launch feature may be utilized across technology-based platforms and devices. For example, and as shown in FIGS. 4A-4E, a desktop computer or laptop 400 may be used to open the website 402 and user-interface 404 and select the product 406 in step 102, to provide the user with an associated 3D model file 410 in step 104, to operate the launch feature via clicking on a clickable button 408 to launch the 3D model file 410 in step 106, and to automatically launch the 3D model file 410 in a software application 412 that the user has downloaded to the desktop computer or laptop 400 in step 108. It should be understood that in the embodiments described herein, the user may be required to log in to the separate software application 412 from the website 402 to confirm that the user has rights and/or security clearance to use the separate software application 412. In other examples, the user may use a mobile device or other smart device 420, as shown in FIGS. 4C-4F. For example, use of an import command, if supported by the deep-link protocol of the separate software application, may permit the direct importation of the retrieved 3D model file 410 into the separate software application 412 that is downloaded on, for example, a mobile smart device 420. The 3D model file 410 may thus be directly launched from the website 402 and viewed in the separate software application 412 via a display of the mobile smart device 420.

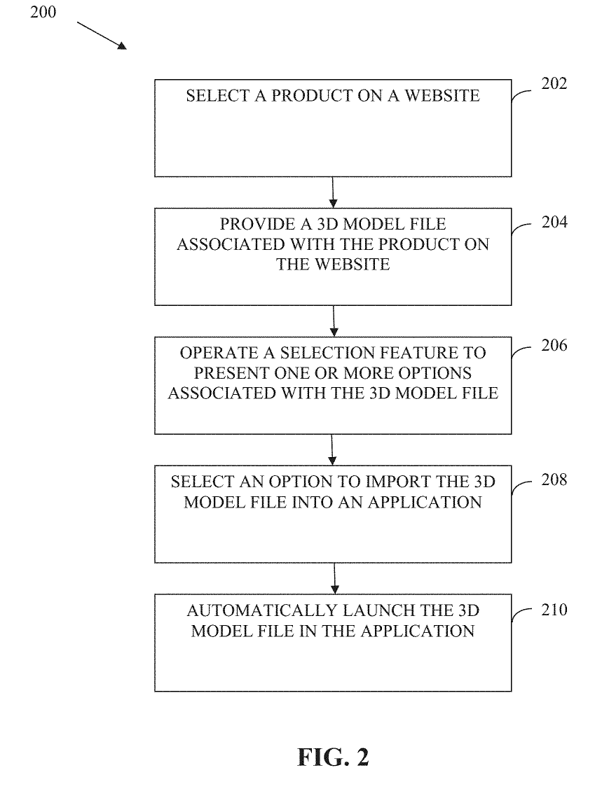

Referring to FIG. 2 and FIGS. 4A-4F, a flow chart of a process 200 for using a selection feature 422 on a website-based tool to select an option to launch a 3D model in a separate application 412 to view the 3D model is shown. In step 202, similar to step 102 of FIG. 1 as described above, a product 406 is selected from a website 402. The product 406 of step 202 may also have an associated 3D model file 410 that is stored in one or more servers accessible by the website 402 by, for example, use of an http protocol. In step 204, also through use of the http protocol, for example, the user is provided with the 3D model file 410 associated with the selected product 406 on the website 402.

In step 206, the user operates a selection feature 422 to present one or more options associated with the 3D model file 410. In step 208, the user selects an option from a plurality of options associated with the selection feature 422 to import the 3D model file 410 into a separate software application 412. In embodiments, the selection feature 422 may be utilized across technology-based platforms and devices. For example, if a deep-link protocol associated with the separate software application 412 does not support an import command for a smart device 420, a user may need to utilize as an extra option a selection step to select an option to instruct the separate software device to display the 3D model file 410 on a display of the smart device 420. In step 210, the 3D model file 410 is then automatically launched in the separate software application 412 based on the selection without requiring the user to first save the 3D model file, separately open the separate software application, search for the saved 3D model file, and open the 3D model file in the separate software application.

In an embodiment, the selection feature 422 may identify the user and an email associated with the user to email the 3D model file 410 to the identified user's associated email. The user may first be requested to confirm the associated email, provide another email if desired, and/or to agree to one or more terms associated with emailing of the 3D model file 410 as presented by the manufacturer or vendor. After the 3D model file 410 is sent to the user's email 424, the user may open the attachment 426. For example, the user may open up the email 424 with the 3D model file attachment 426 on a smart device 420. The user may further tap on the email attachment 426 to be presented with one or more options associated with how the user desires to open the attached 3D model file 410. For example, the user may select an option to import the 3D model file 410 into the separate software application 412. The separate software application 412, which may already be downloaded on the smart device, may then import the 3D model file 410 for viewable display on the smart device 420 without requiring the user to directly open the separate software application 412.

In another embodiment, the selection feature 422 may provide a user of a smart device 420 with a link 428 on the website 402 that is associated with the 3D model file 410 that the user is attempting to launch in the separate software application 412. For example, the user may be utilizing a smart device 420 to access the website 402 and the link 428, and the user may tap on the link 428 to be presented with one or more options associated with how to open the associated 3D model file 410. As with the email attachment 426, the user may select an option to import the 3D model file 410 into the separate software application 412. The separate software application 412 may then import the 3D model file 410 for viewable display on the smart device 420.

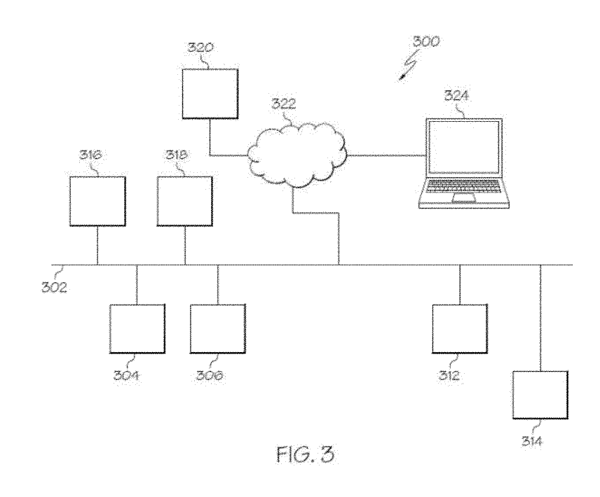

Referring to FIG. 3, a system 300 for implementing a computer and software-based method to utilize the launch tools, as shown in FIGS. 1 and 2, is illustrated as being implemented along with using a graphical user interface (GUI) displaying, for example, a website (such as a vendor or manufacturer website as described herein) and that is accessible at a user workstation (e.g., a computer 324), for example. The system 300 includes a communication path 302, one or more processors 304, a memory component 306, a tool launch option component 312, a storage or database 314, an application component 316, a network interface hardware 318, a network 322, a server 320, and at least one computer 324. The various components of the system 300 and the interaction thereof will be described in detail below.

While only one application server 320 and one user workstation computer 324 is illustrated, the system 300 can include multiple workstations and application servers containing one or more applications that can be located at geographically diverse locations across a plurality of industrial sites. In some embodiments, the system 300 is implemented using a wide area network (WAN) or network 322, such as an intranet or the Internet. The workstation computer 324 may include digital systems and other devices permitting connection to and navigation of the network. Other system 300 variations allowing for communication between various geographically diverse components are possible. The lines depicted in FIG. 3 indicate communication rather than physical connections between the various components.

As noted above, the system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

As noted above, the system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the system 300 may include the processor 360 communicatively coupled to the memory component 306 that stores instructions that, when executed by the processor 360, cause the processor to perform one or more launch tool functions as described herein.

Still referring to FIG. 3, as noted above, the system 300 comprises the display such as a GUI on a screen of the computer 324 for providing visual output such as, for example, information, graphical reports, messages, or a combination thereof. The GUI may present the vendor or manufacturer website, for example, as described herein, which website may display the tool launch option component 312, as described in greater detail below. The display on the screen of the computer 324 is coupled to the communication path 302 and communicatively coupled to the processor 304. Accordingly, the communication path 302 communicatively couples the display to other modules of the system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the system 300 is illustrated as a single, integrated system in FIG. 3, in other embodiments, the systems can be independent systems.

The system 300 comprises the application component 316 that allows a user to view and/or modify one or more 3D models and a tool launch option component 312 to assist with operation of a launch or selection feature from the website to open a selected three dimensional model associated with a website-displayed product in the application component 316, as described above. The application component 316 and the tool launch option component 312 are coupled to the communication path 302 and communicatively coupled to the processor 304. As will be described in further detail below, the processor 304 may process the input signals received from the system modules and/or extract information from such signals.

The system 300 includes the network interface hardware 318 for communicatively coupling the system 300 with a computer network such as network 322. The network interface hardware 318 is coupled to the communication path 302 such that the communication path 302 communicatively couples the network interface hardware 318 to other modules of the system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on computer 324 can be provided from the computer 324 to the system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, satellite networks, or the like. Accordingly, the network 322 can be utilized as a wireless access point by the computer 324 to access one or more servers (e.g., a server 320). The server 320 and any additional servers generally include processors, memory, and chipset for delivering resources via the network 322. Resources can include providing, for example, processing, storage, software, and information from the server 320 to the system 300 via the network 322. For example, the 3D models as described herein may be stored at the server 320 and retrieved from the server 320 via use of http protocol. Additionally, it is noted that the server 320 and any additional servers can share resources with one another over the network 322 such as, for example, via the wired portion of the network, the wireless portion of the network, or combinations thereof.

A user opening multiple applications such as web browsers and separate software applications to view and/or manipulate designs associated with 3D model files of a product that the user is deciding whether or not to purchase from a vendor may spend time to save, search for, and open such files in software applications. During the time spent, a user may save the associated files at locations that the user forgets, adding to the project time, and/or the user may become frustrated with the process. Additionally, such steps are not conducive to the user viewing the 3D model files on, for example, mobile smart devices.

With the launch tools described herein, a user is able to utilize commands supported by with a deep-link protocol of a separate software application and commands that retrieve a 3D model associated with a product on the website from a storage location with a http protocol to directly launch the 3D model from the website into the separate software application. In embodiments, such as with use of smart devices and/or when the deep-link protocol of the separate software application may not support an import command, a user is able to utilize selection features to select an option to directly launch the 3D model from the website into the separate software application. The selection features may include a selection to send an emailed attachment of the 3D model file to the user from the website or a selection of a direct link on the website associated with the 3D model file that is retrieved from a storage location with a http protocol. A plurality of options associated with how to open the selection may present an option to open the selection in the separate software application.

Thus, with the launch tools described herein, a user is able to utilize a website that has a launch tool allowing integration with and/or connection to a separate software application such that a user is able to use the launch tool to launch a 3D model of the 3D model file from the website in the separate software application. The launch tools described herein thus provide for an increased efficiency in the process of launching 3D models while avoiding disjointed steps that would otherwise reduce such efficiency, such as the steps to download a three-dimensional model of a product from a website to be saved as a file, a separate launch of the separate software application, a search for and selection of the saved downloaded model file, and an opening of the saved downloaded model file in the separate software application. The launch tools described herein permit the user to reduce the amount of time needed to directly open the desired 3D model while avoiding such disjointed steps. Moreover, the modification of the website to include the integrated launch tools streamlines and automates the process of launching and viewing the desired 3D model in the separate software application, also allowing for increased efficiency in the process. For example, the launch tools may include code options to simultaneously retrieve a 3D model file associated with a selected product from a storage location while utilizing an insert command, for example, with a deep-link protocol of the separate software application to insert the 3D model file into and automatically launch and open the 3D model in the separate software application. The launch tools may additionally or alternatively include code options to retrieve a 3D model file associated with a selected product from a storage location while utilizing a selection feature that either emails the 3D model file to an identified user email or provides a link to the retrieved 3D model file on the website. The user may select an option of opening the retrieved 3D model file, available through the selection feature, in the separate software application such that the launch tool automatically launches and opens the 3D model in the separate software application.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for launching a three-dimensional model from a website into an application, the method comprising:
receiving through a user-interface of the website an input of a selection by a user of a selected product;
retrieving from a server, by a processor and through use of an http protocol, a 3D model file associated with the selected product;
selecting a launch feature on the user-interface of the website, wherein the launch feature is associated with the 3D model file; and
automatically launching, via the processor, the 3D model file associated with the selected product in a display screen of the application.

2. The method of claim 1, wherein the launch feature operates based on a command code linked to a deep-link protocol associated with the application.

3. The method of claim 2, wherein the deep-link protocol is configured to support the command code comprising at least one of an open command, an import command, and an insert command.

4. The method of claim 1, wherein the launch feature operates based on a command code linked to a deep-link protocol associated with the application.

5. The method of claim 4, wherein the deep-link protocol associated with the application is configured to support an import command for a smart device.

6. The method of claim 4, wherein the deep-link protocol associated with the application is not configured to support an import command for a smart device, the method further comprising:
selecting an intermediate option through a selection feature to instruct the smart device to display on a display of the smart device the 3D model file.

7. The method of claim 6, wherein the intermediate option comprises an email option to electronically send an email including the 3D model file as an attachment to an email address associated with the user, wherein the attachment to the email is configured to present one or more view options for the user with respect to opening the associated 3D model file.

8. The method of claim 7, wherein the one or more view options comprises at least one of an option to import the 3D model file for display on the display of the smart device.

9. The method of claim 6, wherein the intermediate option comprises an option to provide a link option configured to provide the user with a link associated with the 3D model file, wherein the link is configured to present the user with one or more view options with respect to opening the associated 3D model file.

10. The method of claim 9, wherein the one or more view options comprises at least one of an option to import the 3D model file for display on the display of the smart device.

11. A system for launching a three-dimensional model from a website into an application, the system comprising
a server;
a processor communicatively coupled to the server;
a non-transitory computer-readable storage medium storing one or more instructions that, when executed by the processor, cause the processor to:
receive an input of a selection by a user of a selected product from a user-interface of the website;
retrieve a 3D model file associated with the selected product on the website from the server through use of an http protocol;
operate a launch feature associated with the 3D model file and based on a command code linked to a deep-link protocol associated with the application; and
automatically launch the 3D model file associated with the selected product in a display screen of the application.

12. The system of claim 11, wherein the deep-link protocol is configured to support the command code comprising at least one of an open command, an import command, and an insert command.

13. The system of claim 11, wherein the deep-link protocol associated with the application is configured to support an import command for a smart device.

14. The system of claim 11, wherein the deep-link protocol associated with the application is not configured to support an import command for a smart device, and the system further comprises one or more instructions one or more instructions to cause the processor to:
receive a user selection of an intermediate option through a selection feature to instruct the smart device to display on a display of the smart device the 3D model file.

15. The system of claim 14, wherein:
the intermediate option comprises an email option to electronically send an email including the 3D model file as an attachment to an email associated with the user, and
the attachment to the email is configured to present one or more view options for the user with respect to opening the associated 3D model file in the application.

16. The system of claim 15, wherein the one or more view options comprises at least one of an option to import the 3D model file for display on the display of the smart device.

17. The system of claim 14, wherein:
the intermediate option comprises an option to provide a link option configured to provide the user with a link associated with the 3D model file,
the link option is configured to provide the link through at least one of on the website and electronically sent to an email address associated with the user in an email, and
the link is configured to present the user with one or more view options with respect to opening the associated 3D model file in the application.

18. The system of claim 17, wherein the one or more view options comprises at least one of an option to import the 3D model file for display on the display of the smart device.

19. A system for launching a three-dimensional model from a website into an application, the system comprising
one or more servers;
a processor communicatively coupled to the one or more servers;
a non-transitory computer-readable storage medium storing one or more instructions that, when executed by the processor, cause the processor to:
receive an input of a selection by a user of a selected product from a user-interface of the website;
retrieve a 3D model file associated with the selected product on the website from the one or more servers through use of an http protocol;
operate a selection feature to present the user with one or more command options associated with the 3D model file;
receive a user selection from the one or more command options; and
automatically launch the 3D model file associated with the selected product in a display screen of the application based on the user selection.

20. The system of claim 19, wherein:
at least a first command of the one or more command options is based on a command code linked to a deep-link protocol associated with the application and comprising one of an open command, an import command, and an insert command, and
at least a second command of the one or more command options is at least one of an email option and a link option, wherein:
the email option configured to electronically send an email including the 3D model file to an email associated with the user,
the link option configured to provide the user with a link associated with the 3D model file, and
each of the email option and the link option is configured to present the user with one or more view options with respect to the opening the associated 3D model file in the application.
